(19) United States
(12) Patent Application Publication
(10) Pub. No.: US 2013/0077322 A1
(43) Pub. Date: Mar. 28, 2013

(54) Adjustable Light

(71) Applicants: Charles Botkin, Cordova, TN (US); Alan C. Webb, Olive Branch, MS (US); Brian H. Friedman, Collierville, TN (US); Jeremy R. Tarr, Somerville, TN (US); Christophe B. Badarello, Walls, MS (US)

(72) Inventors: Charles Botkin, Cordova, TN (US); Alan C. Webb, Olive Branch, MS (US); Brian H. Friedman, Collierville, TN (US); Jeremy R. Tarr, Somerville, TN (US); Christophe B. Badarello, Walls, MS (US)

(21) Appl. No.: 13/245,185

(22) Filed: Sep. 26, 2011

(51) Int. Cl. F21V 11/00; F21V 21/14

(52) U.S. Cl. 362/355; 362/430

(57) ABSTRACT

A light (10) includes an upper mounting bracket (17), a light socket assembly (26), and a lower mounting bracket (34) and a glass disc mounting bracket (42). The lower mounting bracket includes a central plate (35) and two oppositely disposed arms (39). Each arm has three pairs of vertically spaced screw mounting holes (40). The glass disc mounting bracket (42) is coupled to the lower mounting bracket. The glass disc mounting bracket includes a central portion (43) and two arms (45) which are configured to mate with lower mounting bracket arms. Each arm has a pair of mounting holes (46) therethrough. A pair of threaded mounting screws (47) pass through the glass disc mounting bracket mounting holes and are threaded into one of the three pairs of screw mounting holes within the lower mounting bracket. A light diffusor (54) is coupled to the glass disc mounting bracket.

### TECHNICAL FIELD

This invention relates to lights and particularly to ceiling lights and ceiling fan light kits.

### BACKGROUND OF THE INVENTION

Currently, the bottom of ceiling mounted lights and ceiling fan light kits oftentimes include a light diffusor or bowl which is mounted to the light hardware structure through a bracket and threaded rod. These bowls oftentimes have different shapes or depths, thus requiring different lengths of hardware extending between the ceiling and the bowl or between the light socket assembly and the bowl. Additionally, different types of light sockets also have different heights which also change the spacing between the bowl and the portion of the hardware mounted to the ceiling or ceiling fan. These variations require that the manufacturer of lights to produce mounting brackets or hardware of different lengths, thereby increasing the cost of manufacturing and inventorying these components.

Accordingly, it is seen that a need remains for a light which may be adjustable to accommodate different types of light sockets or/or different diffusor bowls. It is to the provision of such therefore that the present invention is primarily directed.

### SUMMARY OF THE INVENTION

A light comprises an upper mounting bracket, a light switch assembly coupled to the upper mounting bracket, and a lower mounting bracket coupled to a lower portion of the light switch assembly. The lower mounting bracket has a central portion and two oppositely disposed mounting arms extending from the central portion. Each mounting arm has a plurality of vertically spaced mounting holes therein. The light also has a diffusor mounting bracket coupled to the lower mounting bracket. The diffusor mounting bracket has a central portion and two oppositely disposed mounting arms configured to mate with the lower mounting bracket arms. Each mounting arm has a mounting hole therein. Lastly, the light has a fastener extending through each diffusor mounting bracket arm ounting hole and into a lower mounting bracket arm mounting hole. With this construction, the spacing of the diffusor mounting bracket relative to the light switch assembly may vary depending upon the selection of which lower mounting bracket arm mounting hole is selected to receive the fastener.

### BRIEF DESCRIPTION OF THE DRAWING

FIG. 1 is a perspective view of an adjustable light embodying principles of the invention in a preferred form.

FIG. 2 is an exploded view of the adjustable light of FIG. 1, shown with 4 different types of light socket assemblies.

FIG. 3 is a side view of a lower mounting bracket of the adjustable light of FIG. 1.

FIG. 4 is a side view of an adjustable light of FIG. 1 shown in a first position.

FIG. 5 is a side view of an adjustable light of FIG. 1 shown in a second position.

FIG. 6 is a side view of an adjustable light of FIG. 1 shown in a third position.

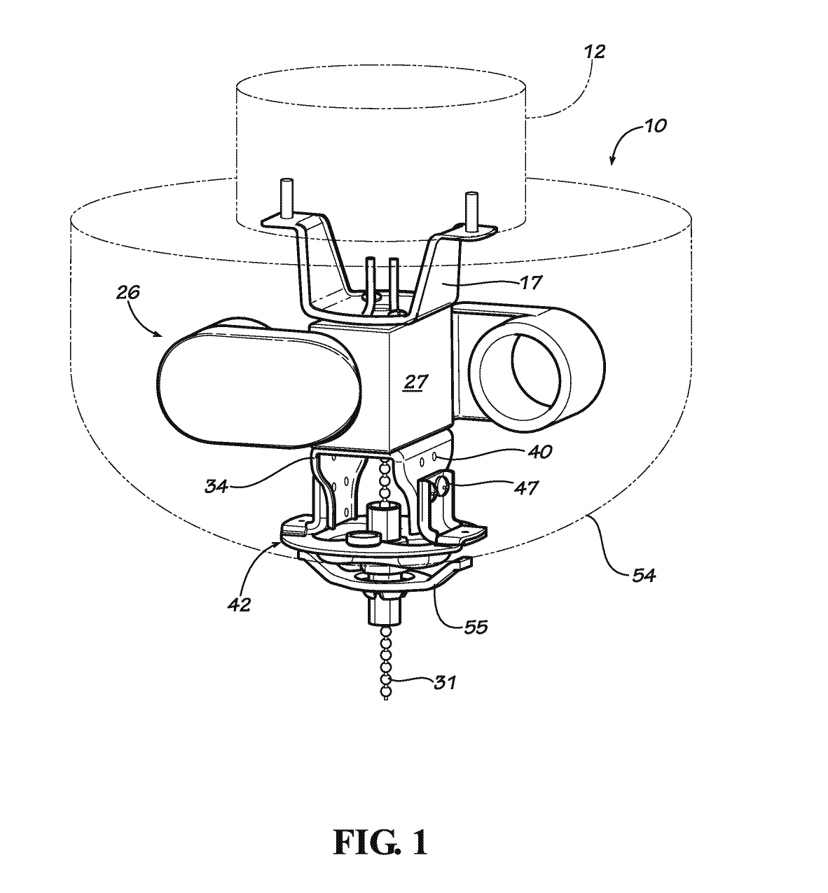

### DETAILED DESCRIPTION

With reference next to the drawings, there is shown a light 10 embodying principles of the invention in a preferred form, shown in the drawings in the form of a ceiling fan light or light kit. The preferred embodiment is shown mounted to a conventional ceiling fan light switch housing 12. However, it should be understood that the light 10 may be configured to be mounted to a ceiling junction box if utilized as a ceiling light.

The light 10 includes an upper mounting bracket 17 which is configured to mate with the bottom of the ceiling fan switch housing 12 or ceiling junction box. The upper mounting bracket 17 includes a bottom plate 18 and two oppositely disposed wings, arms, or flanges 19. The bottom plate 18 has a central wiring hole 20 and two light switch mounting holes 21. Each flange 19 has a mounting hole 22 extending therethrough through which passes a light mounting screw 23 which is then threaded into the ceiling fan switch housing or optionally the ceiling junction box.

A light socket assembly 26, which includes the light switch 27, is coupled to the bottom side of the upper mounting bracket 17 and secured thereto through two mounting screws 28 extending through bottom plate mounting holes 21 and through two mounting holes 29 extending through the light socket assembly 26. The light socket assembly 26 includes a central, cylindrical mounting flange 30 through which a flexible pull chain 31 extends. The actuation or pulling of the pull chain 31, and thus the actuation of the actuation light switch 27, controls the operation of the light 10.

A lower mounting bracket 34 is coupled to the bottom of the light switch 27. The lower mounting bracket 34 includes a central plate 35 having a central mounting hole configured to receive the light socket assembly cylindrical mounting flange 30 and two screw mounting holes 37 into which are threaded the mounting screws 28 to secure the position of the lower mounting bracket. The lower mounting bracket 34 also has two oppositely disposed flanges, wings, or arms 39. Each arm 39 has three horizontally oriented pairs of vertically spaced threaded screw mounting holes 40, i.e., each hole of each pair of holes is horizontally spaced from each other and each pair of holes is vertically spaced from the adjacent pair of holes.

A diffusor or glass disc mounting bracket 42 is coupled to the lower mounting bracket 34. The glass disc mounting bracket 42 includes a central portion 43 having a central mounting hole 44 therethrough and two oppositely disposed, upwardly extending flanges, wings, or arms 45 which are configured to mate with lower mounting bracket arms 39. Each arm 45 has a pair of horizontally oriented mounting holes 46 therethrough. A pair of threaded mounting screws 47 pass through the glass disc mounting bracket mounting holes 46 and are threaded into one of the three pairs of threaded screw mounting holes 40 within the lower mounting bracket 34. An externally threaded hollow rod 49 passes through the central mounting hole 44 and is secured in place by a first nut 50 threaded to an upper portion of the rod and washer 51 and second nut 52 threaded to a lower portion of the rod so as to capture the central plate 50 therebetween. The pull chain 31 passes through the hollow rod 49.

The light 10 also includes a transparent or translucent light diffusor or bowl 54 with a preferably round central mounting hole therethrough adapted to receive a lower portion of rod 49. A glass diffusor retainer 55, or alternatively a threaded finial, having an internally threaded central rod hole 56 is threaded onto the lower portion of the rod and positioned against the underside of the light diffusor to maintain it in place.

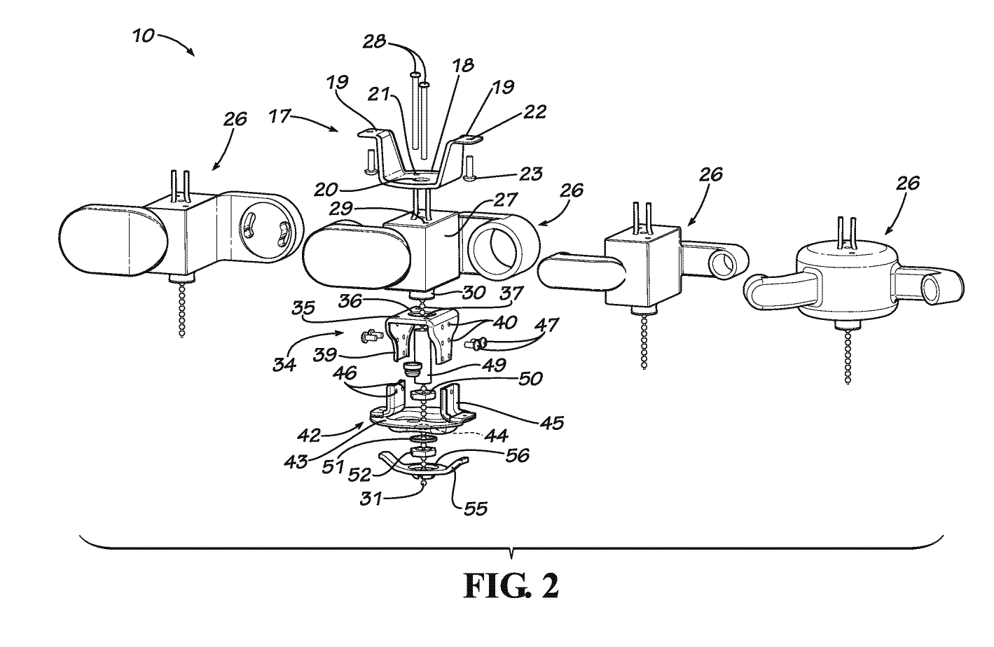

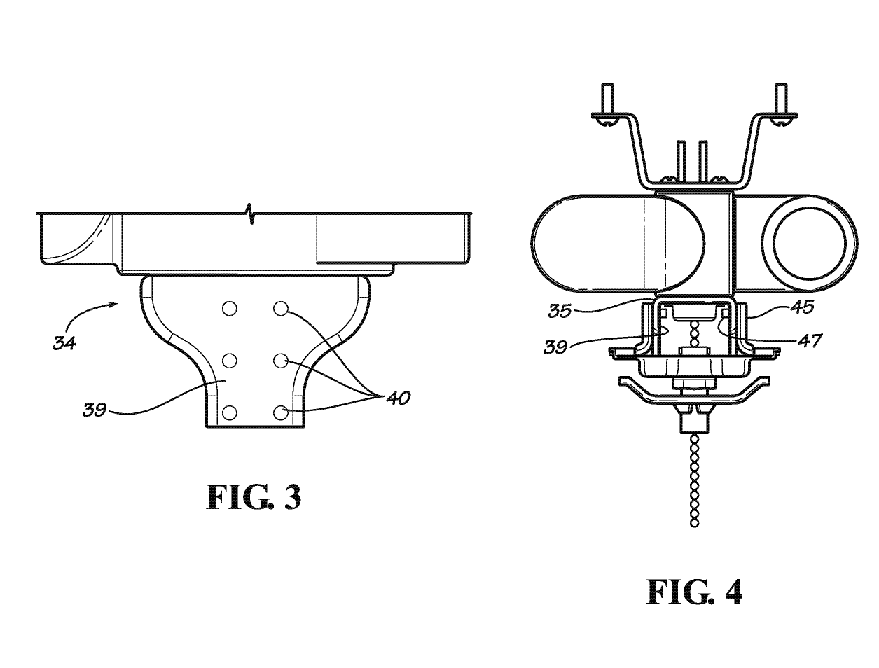

In use, during the manufacturing process of assembling the light fixture 10 a manufacturer selects the type of light socket assembly 26 and diffusor 54 to be utilized. FIG. 2 illustrates four different conventionally know types of light sockets that are identified as examples only and are not limited to such, these example include from left to right in the drawings a GU24 dual socket, an E26 dual socket, an E12 dual socket, and a E12 triple socket. The different light socket assemblies and diffusors may have different heights or spacings which may require different spacing of the diffusor 54 and thus the glass disc mounting bracket 42 from the light socket assembly 26. As such, the manufacturer adjusts the position of the glass disc mounting bracket 42 relative to the light socket assembly 26 by selecting one of the three pairs of lower mounting bracket mounting holes 40 which provide the appropriate spacing. The selection of the highest mounting holes 40 provides the smallest spacing while the selection of the lowest mounting holes 40 provides the largest spacing.

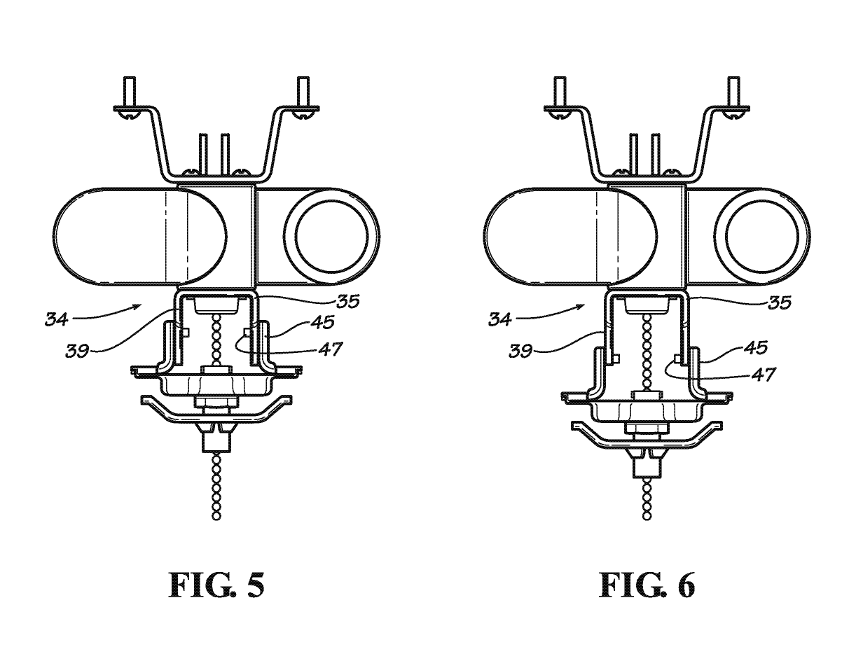

FIGS. 4-6 show three different spacings of the glass disc mounting bracket 42 with the same light bulb assembly. FIG. 4 shows mounting screws 47 threaded into the lower mounting bracket topmost mounting holes 40. FIG. 5 shows mounting screws 47 threaded into the lower mounting bracket middle mounting holes 40. FIG. 6 shows mounting screws 47 threaded into the lower mounting bracket lowermost mounting holes 40. It thus should be understood that the different heights of the mounting holes 40 provides an easy and efficient manner of adjusting the spacing between the diffusor 54 and the light socket assembly. As such, a manufacturer does not have to design and inventory several different brackets to achieve the same purpose, i.e., a manufacture does not have to design a bracket for each light design or selection of a particular type of light socket assembly. This flexibility allows a manufacturer to produce a fewer variety of brackets and requires less inventory to store the fewer variety, thus economizing space, time and the manufacturing process.

It should be understood that the present invention may include any reasonable number of pairs of mounting holes 40 greater than one to provide a selection of heights, and is not limited to the three pairs shown in the preferred embodiment. Also, it should be understood that mounting holes 40 need not be limited to pairs of holes and may instead include only one hole per height on each arm 39. Also, as an equivalent alternative, the glass disc mounting bracket 42 may include the series of vertically oriented holes while the lower mounting bracket arm 39 includes one hole, thus allowing the glass disc mounting bracket to be set at various heights depending upon the selection of which vertically oriented hole the manufacturer selects to utilize. Lastly, the mounting screws 47 may be substituted with other types of mounting or securing means, such as rivets, bolts, clips, or other conventionally known fasteners.

It thus is seen that a light is now provided which overcomes problems associated with lights of the prior art. While this invention has been described in detail with particular references to the preferred embodiments thereof, it should be understood that many modifications, additions and deletions, in addition to those expressly recited, may be made thereto without departure from the spirit and scope of the invention.

1. A light comprising,
an upper mounting bracket;
a light switch assembly coupled to said upper mounting bracket;
a lower mounting bracket coupled to a lower portion of said light switch assembly, said lower mounting bracket having a central portion and two oppositely disposed mounting arms extending from said central portion, each said mounting arm having a plurality of vertically spaced mounting holes therein,
a diffusor mounting bracket coupled to said lower mounting bracket, said diffusor mounting bracket having a central portion and two oppositely disposed mounting arms configured to mate with said lower mounting bracket arms, each mounting arm having a mounting hole therein, and
a fastener extending through each diffusor mounting bracket arm mounting hole and into one said lower mounting bracket arm mounting hole,
whereby the spacing of the diffusor mounting bracket relative to the light switch assembly may vary depending upon the selection of which lower mounting bracket arm mounting hole is selected to receive the fastener.

2. The light of claim 1 further comprising a light diffusor coupled to said diffusor mounting bracket arm.

3. The light of claim 1 wherein said lower mounting bracket arms have horizontally oriented pairs of vertically space mounting holes therein.

4. The light of claim 1 wherein said lower mounting bracket central portion and said diffusor mounting bracket central portion each have a central opening therein, and wherein said light switch assembly includes a pull chain extending through said central openings of said lower mounting bracket central portion and said diffusor mounting bracket central portion.

5. A light comprising,
an upper mounting bracket;
a light switch assembly coupled to said upper mounting bracket, and
a lower mounting bracket assembly coupled to said light switch assembly, said lower mounting bracket assembly including a first bracket portion having a central portion and two oppositely disposed mounting arms extending from said central portion and a second bracket portion having a central portion and two oppositely disposed mounting arms extending from said central portion, each of said arms of either said first bracket portion or said second bracket portion having a plurality of vertically spaced mounting holes therein, each of said arms of the other said first bracket portion or said second bracket portion having a mounting hole therein, and a fastener extending through at least one said mounting hole of each said arm of said first and second bracket portions.

6. The light of claim 5 further comprising a light diffusor coupled to said lower mounting bracket assembly.

7. The light of claim 5 wherein said plurality of vertically spaced mounting holes includes a plurality of vertically spaced pairs of horizontally oriented mounting holes.

8. The light of claim 5 wherein said first bracket portion and said second bracket portion each have a central opening therein, and wherein said light switch assembly includes a pull chain extending through said central openings of said first bracket portion and said second bracket portion.

9. A light comprising,
an upper mounting bracket;
a light switch assembly coupled to said upper mounting bracket, and
a lower mounting bracket assembly coupled to said light switch assembly, said lower mounting bracket assembly including a first bracket portion having at least one mounting arm having a plurality of vertically spaced mounting holes therein, said lower mounting bracket assembly also including a second bracket portion having at least one mounting arm having a mounting hole therein, and a fastener extending through one said mounting hole of said first bracket portion arm plurality of mounting holes and through said mounting hole of said second bracket portion arm.

10. The light of claim 10 wherein said first bracket portion includes two oppositely disposed arms and said second bracket portion includes two oppositely disposed arms configured to mate with said first bracket portion arms.

11. The light of claim 9 further comprising a light diffusor coupled to said lower mounting bracket assembly.

12. The light of claim 9 wherein said plurality of vertically spaced mounting holes includes a plurality of vertically spaced pairs of horizontally oriented mounting holes.

13. The light of claim 9 wherein said first bracket portion and said second bracket portion each have a central opening therein, and wherein said light switch assembly includes a pull chain extending through said central openings of said first bracket portion and said second bracket portion.
